(19) United States
(12) Patent Application Publication
(10) Pub. No.: US 2026/0145494 A1
(43) Pub. Date: May 28, 2026

(54) Off-Road Vehicle With Sealed Door

(71) Applicant: Zhejiang CFMOTO Power Co., Ltd., Hangzhou (CN)

(72) Inventors: Meilin Feng, Hangzhou (CN); Wenjian Li, Hangzhou (CN); Lihua Rao, Hangzhou (CN); Yaofang ZHANG, Hangzhou (CN); Haifeng Liang, Hangzhou (CN)

(21) Appl. No.: 19/178,573

(22) Filed: Apr. 14, 2025

(30) Foreign Application Priority Data
Apr. 16, 2024 (CN) 202410460163.1
Apr. 26, 2024 (CN) 202410509377.3
Apr. 26, 2024 (CN) 202410509538.9
Apr. 26, 2024 (CN) 202420881958.5

(51) Int. Cl. B60J 5/04; B60J 10/86

(52) U.S. Cl. CPC B60J 5/0487; B60J 10/86

(57) ABSTRACT

An off-road vehicle includes a frame, a plurality of wheels, a prime mover system, and a door assembly. The door assembly includes a door frame seal, a window with a movable pane and a window seal. The door frame seal includes a seal body, an exterior seal wing, and an interior seal wing, with the two seal wings independently abutting differently oriented surfaces of the frame when the door assembly is closed. The window seal includes an exterior wing, a top wing and an interior wing, all three mating in an interference fit against different surfaces at a top of a movable pane when it is closed, as well as upper and lower exterior seal wings and upper and lower interior seal wings positioned in opposing interference fits against surfaces at a bottom of the window when the movable pane is closed.

### RELATED APPLICATION INFORMATION

The present application claims the benefits of priority to Chinese Patent Application No. 202410460163.1, filed with the Chinese Patent Office on Apr. 16, 2024, Application No. 202410509538.9, filed with the Chinese Patent Office on Apr. 26, 2024, Application No. 202410509377.3, filed with the Chinese Patent Office on Apr. 26, 2024, and Application No. 202420881958.5, filed with the Chinese Patent Office on Apr. 26, 2024. The entire contents of the above-referenced applications are incorporated herein by reference.

### FIELD OF THE DISCLOSURE

The present application relates to the field of off-road vehicles, and particularly to sealing of door assemblies of off-road vehicles.

### BACKGROUND OF THE DISCLOSURE

An off-road vehicle is a type of vehicle that can travel on many different types of terrain, often on roads, trails or fields with complex terrain such as including mud, sand, rocks, downed trees and other obstacles. While some off-road vehicles are open air, others have doors and roofs. In existing off-road vehicles that have doors, there may be a large gap between the doors and the frame of the vehicle. Manufacturing tolerances can contribute to this large gap. Considerable amounts of external impurities (mud, dirt, stones, etc.) may enter the cabin through the large gap during the running of the off-road vehicle, thereby dirtying and/or polluting the environment of the cabin.

In some existing off-road vehicles, the doors and frame may be sealed by door frame seals, but the sealing effect of the existing door frame seals is inadequate for the off-road environment. External impurities (mud, dirt, stones, etc.) can be kicked up and still enter the cabin past the door frame seal. Better solutions are needed.

### SUMMARY OF THE INVENTION

In order to address the shortcomings of existing vehicles, the purpose of the present application is to provide an off-road vehicle with good sealing between the door assembly and the frame.

The present invention is an off-road vehicle which achieves one or more of the above objectives. The off-road vehicle includes a frame, a plurality of wheels, a prime mover system, and a door assembly. The plurality of wheels support the frame. The prime mover system is supported by the frame and drives at least some of the plurality of wheels. The door assembly is pivotally mounted on the frame. The door assembly includes a door frame assembly, a door frame seal, a window, and a window seal. The door frame assembly is pivotally connected to the frame, and the door frame seal is disposed around the door frame assembly to seal the gap between the door frame assembly and the frame. The window is mounted on the door frame assembly and is transparent or translucent to allow viewing therethrough. The window seal is disposed around the window. The door frame seal includes a seal body, an exterior seal wing, and an interior seal wing. The exterior seal wing and the interior seal wing both independently extend from the seal body, and the seal body is clamped or fixedly connected to the door frame assembly. The frame has a laterally-extending contact surface and a side contact surface. The lateral contact surface is adjacent to the side contact surface and oriented differently from the side contact surface. When the door assembly is in a closed state, the exterior seal wing abuts against the lateral contact surface in an interference fit without contacting the side contact surface, and the interior seal wing abuts against the side contact surface in an interference fit without contacting the lateral contact surface.

In another aspect, the window has at least one movable pane, and the door assembly includes exterior and interior door panels. An exterior wiping seal is secured to the exterior door panel, and an interior wiping seal is secured to the interior door panel. The exterior wiping seal has lower and upper seal wings extending from an exterior wiping seal body. The exterior wiping seal body is secured to the exterior door panel such that the lower and upper seal wings of the exterior wiping seal mate in an interference fit with an exterior surface of the movable pane. The interior wiping seal also has lower and upper seal wings extending from its seal body, and is secured to the interior door panel such that the lower and upper seal wings of the interior wiping seal mate in an interference fit with an interior surface of the movable pane.

In another aspect, the window seal includes a top edge wing in addition to exterior and interior pane wings. When the movable pane is closed, the top edge wing abuts in an interference fit against a top edge of the movable pane, the exterior pane receiving wing abuts in an interference fit against an outer surface of the movable pane, and the interior pane receiving wing abuts in an interference fit against an inner surface of the movable pane.

The present invention thus achieves double sealing, so external dust, dirt, mud and other impurities are prevented from entering the cabin, thereby improving the sealing performance of the door assembly.

### BRIEF DESCRIPTION OF THE DRAWINGS

FIG. 1 is a front left perspective view of an off-road vehicle in accordance with the present application.

FIG. 2 is a rear right (inside) exploded perspective view of the left door assembly shown in the off-road vehicle of FIG. 1.

FIG. 3 is a left (outside) view of the window and part of the door frame assembly of the left door assembly of FIG. 2, further schematically showing portions of the frame of the off-road vehicle of FIG. 1.

FIG. 4 is a cross-sectional view taken at the position of cut line 4-4 in FIG. 3, but of the roll cage tube, door frame seal, window frame, window seal, window, and exterior and interior door panels of FIG. 2

FIG. 5 is an enlargement of part 5 in FIG. 4.

FIG. 6 is an exploded cross-sectional view of the door assembly and roll cage tube structures shown in FIG. 5.

FIG. 7 is an exploded perspective right (inside) view of the inside of portions of the window frame, one of the side window frames, and window seal of FIG. 2.

FIG. 8 is an enlargement of part 8 in FIG. 4.

FIG. 9 is an exploded cross-section view of the door assembly structures shown in FIG. 8.

FIG. 10 is a left (outside) side view of the left door assembly of FIGS. 1 and 2, not showing the interior or exterior door panels and showing upper, intermediate and lower positions of the window support base.

FIG. 11 is a front left (outside) perspective view of the door assembly structures shown in FIG. 10.

### DETAILED DESCRIPTION

For better understanding of the above objects, features and advantages of the present invention, embodiments of the present disclosure will be described in detail below with reference to the accompanying drawings.

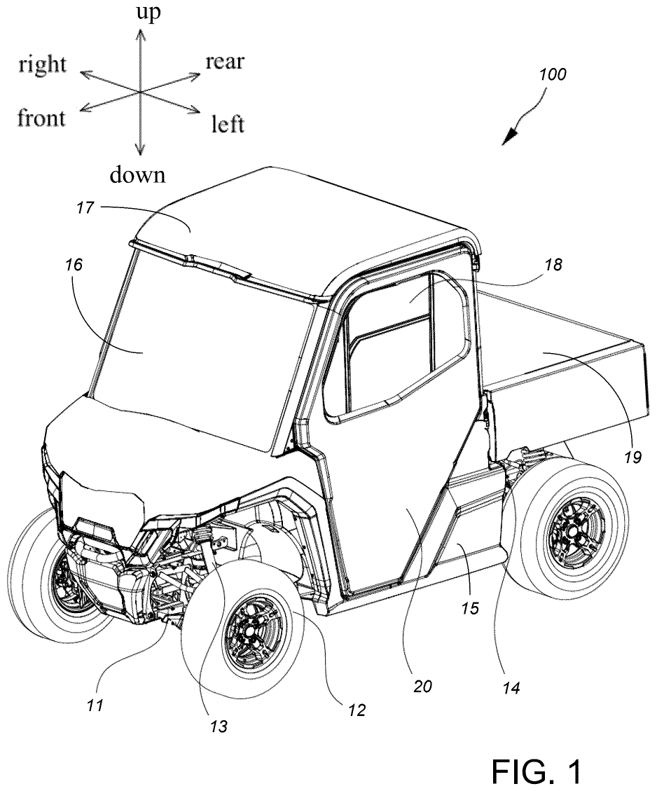

FIG. 1 shows an off-road vehicle 100, which includes a frame 11, a plurality of wheels 12, a suspension system 13 and a prime mover system 14. The frame 11 serves as a basic structural support of the off-road vehicle 100 for connecting and carrying the plurality of wheels 12, the suspension system 13, and the prime mover system 14. The plurality of wheels 12 is connected to the frame 11 through the suspension system 13, with the plurality of wheels 12 being positioned at least partially under the frame 11. The prime mover system 14 is connected to the plurality of wheels 12 to drive the movement of at least some of the plurality of wheels 12 and thereby provide locomotive power for the off-road vehicle 100. The frame 11 is substantially covered by a number of covering members including a side panel 15, a windshield 16 and a roof 17, with a cabin 18 defined behind the windshield 16 and under the roof 17 for transport of a driver and possibly at least one passenger. A cargo box 19 may be provided for the off-road vehicle 100 to carry cargo, items, materials or other loads. Two door assemblies 20, one on the left typically for the driver and one on the right typically for any passengers, are pivotally connected to frame 11 for ingress and egress of the driver and any passengers to and from the cabin 18. The door assemblies 20, windshield 16 and roof 17 are supported by the frame 11 to cooperatively define and substantially enclose the cabin 18.

The general orientations of front, rear, up (upper), down (lower), left and right for the off-road vehicle 100 are defined in FIG. 1 for better understanding of the drawings. In the present application, a length or longitudinal direction of the off-road vehicle 100 refers to a direction from front to back as shown in FIG. 1; a width (lateral or transverse) direction of the off-road vehicle 100 refers to a direction from left to right as shown in FIG. 1, and a height direction of the off-road vehicle 100 refers to a direction from down to up as shown in FIG. 1. In the preferred embodiment, the door assembly 20 is hinged at the rear, and people pass in front of the opened door assembly 20 to enter and leave the cabin 18. However, the present invention is equally applicable to doors hinged at other locations.

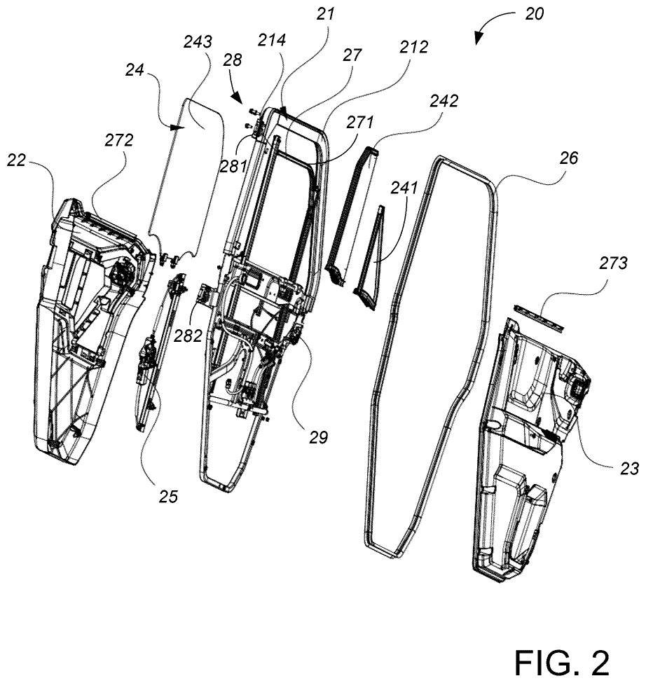

The separate components of the preferred door assembly 20 are better shown in FIG. 2. The door assembly 20 includes a door frame assembly 21 at least partially sandwiched between an exterior door panel 22 and an interior door panel 23. The door frame assembly 21 serves as the basic structural support for the door assembly 20. The exterior door panel 22 and the interior door panel 23 serve to wrap, isolate and protect interior components of the door assembly 20 from precipitation and dirt. A window 24 is positioned on an upper side of the door assembly 20, formed substantially of a transparent or translucent material such as glass or polycarbonate so people can view in to the cabin 18 and can view out through sides of the cabin 18. A movement mechanism 25 is positioned on the door frame assembly 21 between the exterior door panel 22 and an interior door panel 23 for raising and lowering at least a portion of the window 24. For instance, the preferred window 24 includes a front fixed pane 241, a rear fixed pane 242 and a central movable pane 243, with the movement mechanism 25 being used for raising and lowering the movable pane 243. A door frame seal 26 extends around a periphery of the door frame assembly 21 to seal between the door assembly 20 and the vehicle frame 11. A window seal 27 seals at least the movable pane 243 relative to the door frame assembly 21. The door assembly 20 further includes hinges 28 such as an upper hinge 281 and a lower hinge 282 and a door lock 29.

It should be noted that alternative embodiments omit one or more of the panes 241, 242, 243 or add additional panes (not shown). That is, the window 24 could be entirely fixed, entirely movable or a combination of fixed and movable panes without limiting many aspects of the present invention.

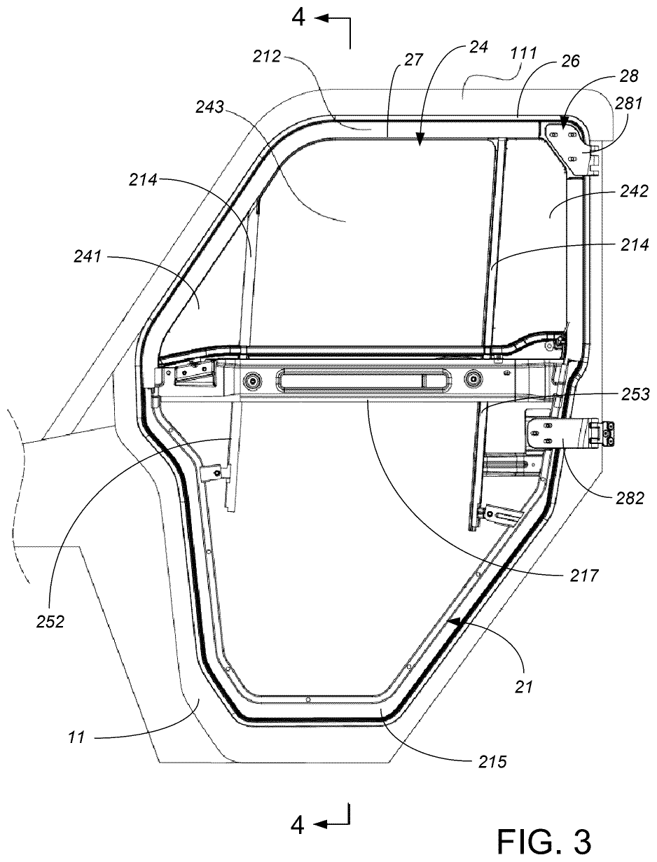

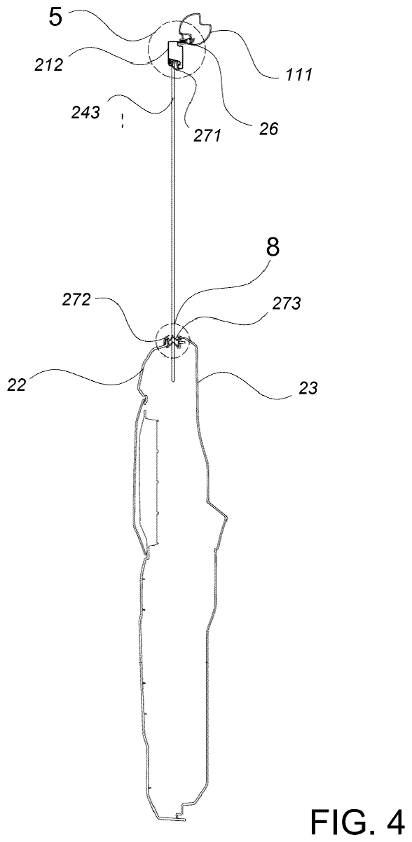

As better shown in FIGS. 3 and 4, the preferred door frame seal 26 seals the gap between the door assembly 20 and the frame 11 when the door assembly is closed. The door frame seal 26 is clamped, adhered or otherwise stably connected around the periphery of the door frame assembly 21. The door frame seal 26 is at least partially formed of a compressible and/or elastically deformable material and is designed to improve the sealing performance of the off-road vehicle 100.

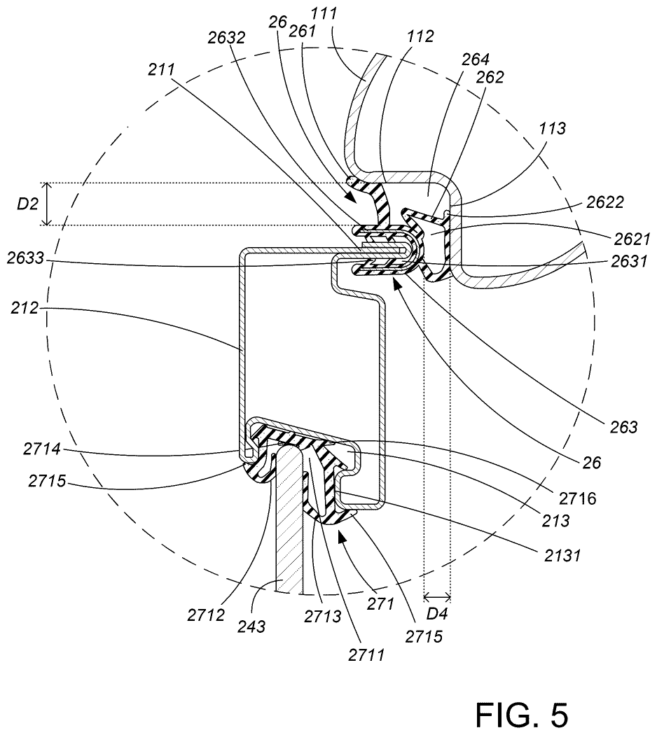

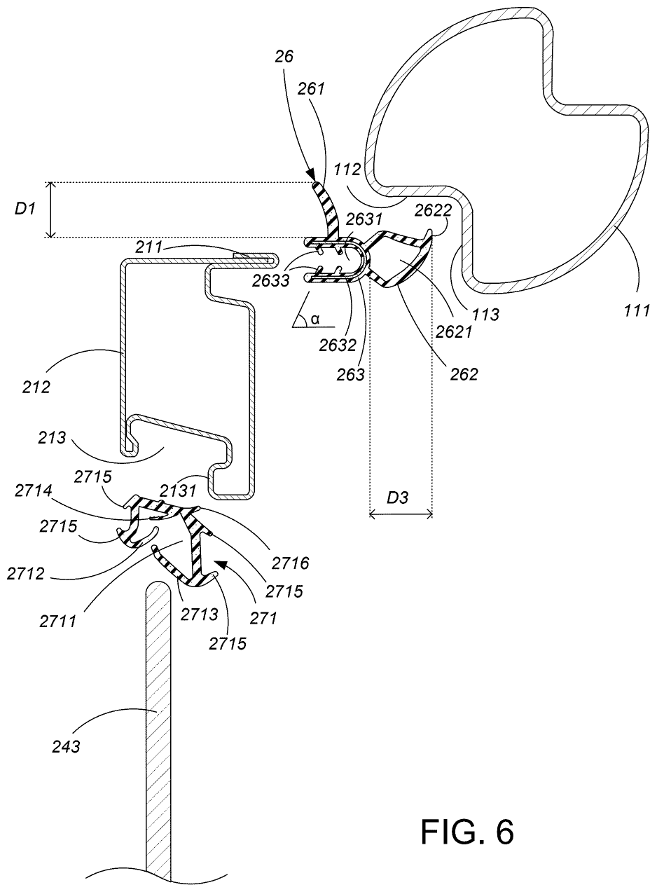

The frame 11 is preferably formed of tubular metal members which substantially encircle the door assembly 20. For instance, part of the frame 11 may be provided as a roll cage tube 111 having a cross-sectional shape substantially as disclosed in U.S. Pat. No. 10,618,383, incorporated by reference. Thus, the roll cage tube 111 provides a laterally extending peripheral contact surface 112 and a vertically extending side contact surface 113 as called out in FIGS. 5 and 6.

As best shown in FIGS. 5 and 6, the preferred door frame seal 26 includes an exterior seal wing 261 and an interior seal wing 262 both independently extending from a seal body 263. The exterior seal wing 261 extends in a first direction, and the interior seal wing 262 extends in a second direction different from the first direction. When the door assembly 20 is closed, the exterior seal wing 261 abuts against the frame 11 in an interference fit, and the interior seal wing 262 abuts against the frame 11 in an interference fit. More specifically, when the preferred door frame seal 26 is used to seal between the roll cage tube 111 and the closed door assembly 20, the exterior seal wing 261 extends vertically to seal via bending against the lateral contact surface 112 without contacting the side contact surface 113, and the interior seal wing 262 extends laterally to seal via compression against the side contact surface 113 without contacting the lateral contact surface. Other, alternative door orientations or frame tube shapes may call for other, alternative orientations of the exterior seal wing 261 and/or interior seal wing 262. This aspect of the present invention achieves independent double sealing between the door assembly 20 and the frame 11 through the exterior seal wing 261 and interior seal wing 262, so the noise transmitted to cabin 18 can be reduced, and external dust, dirt, mud and other impurities can be prevented from entering the cabin 18. The independent double sealing enhances the sealing between door assembly 20 and frame 11, improving the cleanliness of cabin 18 and improving the comfort of off-road vehicle 100. During the running of the off-road vehicle 100, the double sealing provided by the exterior seal wing 261 and the interior seal wing 262 can significantly reduce airflow into the cabin 18, thereby improving the noise, vibration and harshness (“NVH”) performance of the off-road vehicle 100. Further, even if one of the exterior seal wing 261 or interior seal wing 262 becomes torn, miss-shapened or damaged, the other of the exterior seal wing 261 and interior seal wing 262 can maintain the seal.

While alternative embodiments could attach the door frame seal 26 to the frame 11, the preferred seal body 263 is clamped, adhered or otherwise connected to the door frame assembly 21. In the preferred embodiment, the peripheral edge of the door frame assembly 21 extends at least partially towards the cabin 18 to define a seal clamping flange 211. For example, the door frame assembly 21 includes a window frame 212 for accommodating and extending around the window 24. The front, upper and rear edges of the window frame 212 extend at least partially toward the cabin 18 to define a portion of the seal clamping flange 211. The door frame seal 26 includes a clamping slot 2631 defined on the seal body 263. During assembly, the seal body 263 is pressed laterally on to the seal clamping flange 211 with the seal clamping flange 211 received in the clamping slot 2631, thereby stably securing the door frame seal 26 to the door frame assembly 21. A metal seal reinforcement strip 2632 is embedded into the seal body 263 to maintain the shape of the seal body 263, thereby preventing excessive deformation before and during assembly.

In the preferred embodiment, the seal body 263 includes several fins 2633 defined as deformable protrusions in the clamping slot 2631. The fins 2633 mate with the seal clamping flange 211 in an interference fit. In the preferred embodiment as called out in FIG. 6, a fin angle α defined between an extension direction of the fins 2633 and an insertion direction of the seal body 263 onto the seal clamping flange 211 is acute. The acute fin angle α makes installation easy while helping to prevent the seal body 263 from falling off of the seal clamping flange 211. In the most preferred embodiment, the fin angle α is about 65°. The metal seal reinforcement strip 2632 helps to maintain pressure of the fins 2633 against the seal clamping flange 211. The positions, orientations and quantity of the fins 1632 within the clamping slot 2631 can be adjusted based upon their dimensions and the material of the seal body 263 to provide a tight but easily assembled connection which can still be dissembled when needed. The fins 2633 help make the connection between the seal clamping flange 211 and the seal body 263 more stable over a wider range of manufacturing tolerances.

A comparison between the shapes of the seal wings 261, 262 in FIGS. 5 and 6 shows the preferred deformation of the door frame seal 26 when the door assembly 20 is shut. Upon closing of the door assembly 20, interference with the roll cage tube 111 causes both the exterior seal wing 261 and the interior seal wing 262 to deform. However, because the motion of the door assembly 20 is very different relative to the orientation of the lateral or outer contact surface 112 (door assembly 20 moves generally parallel to the lateral contact surface 112) than relative to the orientation of the side contact surface 113 (door assembly 20 moves generally perpendicular to the side or inner contact surface 113), the exterior seal wing 261 is designed with a very different shape than the interior seal wing 262.

The preferred exterior seal wing 261 is shaped as a strip extending vertically outward from the periphery of the door assembly 20. In the vertical cross-section shown in FIG. 6, an extension length of the exterior seal wing 261 along the height direction of the off-road vehicle 100 is defined as an undeformed exterior wing distance D1. When the door assembly 20 is closed as shown in FIG. 5, the vertical distance between the seal body 263 and the lateral contact surface 112 of the roll cage tube 111 is defined as a peripheral door gap distance D2. The undeformed exterior wing distance D1 is greater than the peripheral door gap distance D2, causing the interference fit which improves the seal effect between the frame 11 and the door assembly 20. When the door assembly 20 is closed, the exterior seal wing 261 bends outwardly, to the left as shown in FIG. 5. An exterior seal deformation ratio D2/D1 of the peripheral door gap distance D2 to the undeformed exterior wing distance D1 is preferably in the range from 58% to 88%, more preferably in the range from 67% to 78%, and most preferably about 70%. Designing the exterior seal deformation ratio D2/D1 to be within these values allows the door assembly 20 to be able to close with an excellent seal effect, reducing noise entering the cabin 18, and preventing external impurities from entering the cabin 18.

The preferred interior seal wing 262 is shaped as a single horizontally-extending accordion fold with a cavity 2621 and a guide edge 2622. In the vertical cross-section shown in FIG. 6, an extension length of the interior seal wing 262 along the width direction of the off-road vehicle 100 is defined as an uncompressed interior wing distance D3. When the door assembly 20 is closed as shown in FIG. 5, the horizontal distance between the seal body 263 and the side contact surface 113 of the roll cage tube 111 is defined as a door side gap distance D4. The uncompressed interior wing distance D3 is greater than the door side gap distance D4, causing the interference fit which improves the seal effect between the frame 11 and the door assembly 20. When the door assembly 20 is closed, the interior seal wing 262 compresses laterally. An interior seal compression ratio D4/D3 of the door side gap distance D4 to the uncompressed interior wing distance D3 is preferably in the range from 29% to 45%, more preferably in the range from 33% to 41%, and most preferably about 37%. Designing the interior seal compression ratio D4/D3 to be within these values allows the door assembly 20 to be able to close with an excellent seal effect, reducing noise entering the cabin 18, and preventing external impurities from entering the cabin 18. The cavity 2621 becomes smaller in volume upon closing of the door assembly 20, facilitating deformation of the interior seal wing 262 and allowing these small values of interior seal compression ratio D4/D3 to occur with minimum side pressure on the door assembly 20. The guide edge 2622 helps control the direction of deformation of the interior seal wing 262 and increases the contact area between the interior seal wing 262 and the side contact surface 113, further improving the seal performance of the interior seal wing 262. The guide edge 2622 preferably extends away from the cabin 18 (directed upwardly in FIGS. 5 and 6), making it more difficult for external impurities to enter the cabin 18.

The exterior seal wing 261 and the interior seal wing 262 cooperatively define a drainage channel 264 therebetween. When the door assembly 20 is in the closed state, the drainage channel 264 helps discharge any precipitation, impurities, mud, etc. that gets past the exterior seal wing 261 to be discharged prior to passing the interior seal wing 262 and entering the cabin 18, thereby further improving the seal performance of the door frame seal 26.

The window seal 27 is disposed around the window 24 and seals between the door frame assembly 21 and at least the movable pane 243 of the window 24 when closed. The movable pane 243 being closed refers in the preferred embodiment to the state when the movement mechanism 25 lifts the movable pane 24 to its highest elevation. The window seal 27 is located between the window frame 212 and the window 24. In the preferred embodiment, the window seal 27 includes at least a top edge seal 271 shown in FIG. 2, and 5-7, and an exterior wiping seal 272 and an interior wiping seal 273 shown in FIGS. 2, 8 and 9.

The top edge seal 271 is positioned on an opposing side of the window frame 212 as the seal body 263. In this position, there will be no interference between the door frame seal 26 and the window seal 27, thereby improving the working stability and seal effect of both the door frame seal 26 and the window seal 27.

The top edge seal 271 defines a pane receiving slot 2711 positioned between an exterior pane receiving wing 2712 and an interior pane receiving wing 2713. The movable pane 243 is received in the pane receiving slot 2711, mating with both the receiving wings 2712, 2713 in an interference fit. When the movable pane 243 is closed, it deflects both the receiving wings 2712, 2713 upwardly, in the direction of motion of the movable pane 243 and further into the pane receiving slot 2711. The interference fit between the pane receiving wings 2712, 2713 and the movable pane 243 makes the seal more stable and improves seal performance, thereby reducing the inflow of impurities such as dust, dirt and mud from entering the cabin 18, thereby improving the cleanliness of the cabin 18 and enhancing the comfort of the off-road vehicle 100. The interference fit between the pane receiving wings 2712, 2713 and the movable pane 243 also improves the NVH performance of the off-road vehicle 100.

The preferred top edge seal 271 further includes a top edge wing 2714 positioned at the base of the pane receiving slot 2711. When the movable pane 243 is closed, it also deflects the top edge wing 2714 upwardly. The top edge wing 2714 seals against the top edge of the movable pane 243, further improving seal performance.

The top edge seal 271 is preferably installed into a seal clamping slot 213 defined on a bottom of the window frame 212, opposite the seal clamping flange 211. The seal clamping slot 213 preferably includes a neck 2131 to help retain the top edge seal 271 in the seal clamping slot 213. The top edge seal 271 preferably includes four fixing ridges 2715 which mate around top and bottom edges of the neck 2131. The top edge seal 271 is clamped into the seal clamping slot 213 using the fixing ridges 2715, helping to better seal and retain the top edge seal 271 into the seal clamping slot 213.

The upper surface of the top edge seal 271 can include one or more additional sealing protrusions 2716. The additional sealing protrusion(s) 2716 mate(s) with the seal clamping slot 213 in an interference fit to further improve the sealing performance of the top edge seal 271 to the window frame 212.

The door frame seal 26 and the top edge seal 271 can be installed and fixed independently and/or simultaneously on the window frame 212, which facilitates the installation and repair of the door frame seal 26 and the window seal 27. To best form both the seal clamping flange 211 and the seal clamping slot 213, the window frame 212 is preferably a hollow structure formed through a rolling process to reduce the difficulty of processing while maintaining structural strength at light weight. The cross-sectional area of the window frame 212 as shown in FIGS. 5 and 6 is preferably in the range from 850 mm² to 1150 mm², more preferably in the range from 920 mm² to 1050 mm², and most preferably about 1000 mm². Both the seal clamping flange 211 and the seal clamping slot 213 with its neck 2131 increase the structural strength of the hollow window frame 212, thereby preventing deformation of the window frame 212 under stress and improving the service life of the door frame assembly 21.

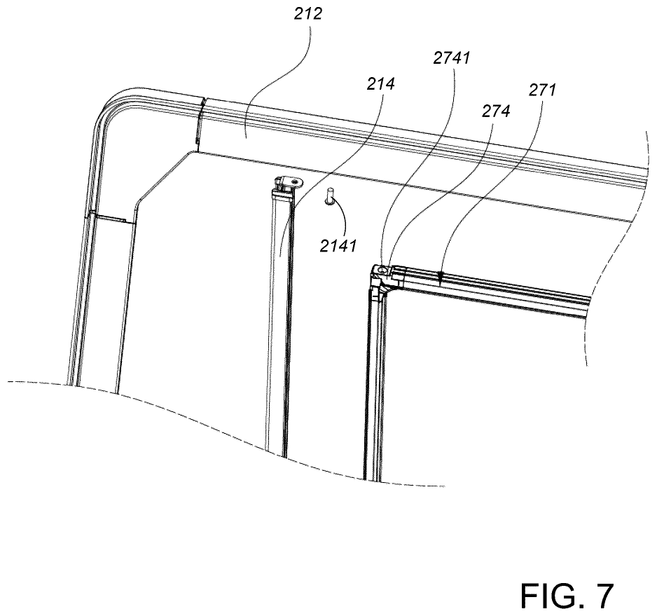

The fixed panes 241, 242 are mounted and fixed to the door frame assembly 21 using one or more side window frames 214, one of which is better shown in FIG. 7. Each of the side window frames 214 is preferably fixedly connected to the window frame 212 through one or more bolts 2141, each of which is located at the connection between the window frame 212 and the side window frame 214. The preferred window seal 27 further includes a wrapping corner 274 for covering each of the bolts 2141. The preferred wrapping corner 274 includes a bolt receiving recess 2741 having an inner contour substantially the same as the outer contour of the head of the bolt 2141, so that the bolt 2141 is at least partially located in the bolt receiving recess 2741. The bolt 2141 is thus hidden in the wrapping corner 274, thereby preventing the bolt 2141 from being exposed to precipitation and other outside impurities, thereby improving the service life of the bolt 2141 and enhancing the stability of the connection between the window frame 212 and the side window frame 214.

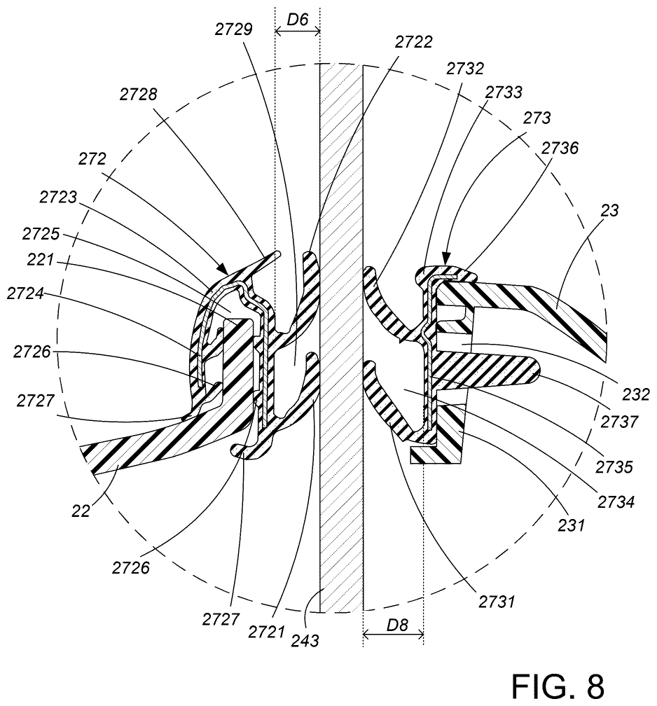

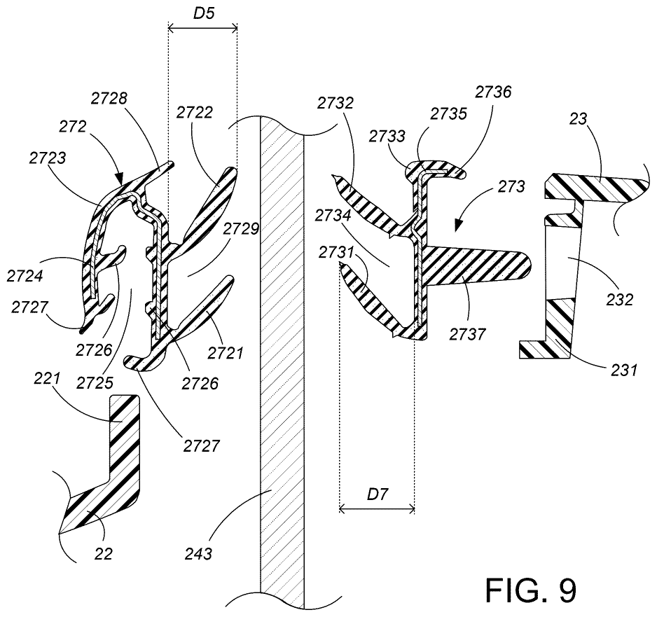

The exterior wiping seal 272 seals between at least the movable pane 243 of the window 24 and the exterior door panel 22, and the interior wiping seal 273 seals between at least the movable pane 243 of the window 24 and the interior door panel 23. The wiping seals 272 and 273 are best shown in FIGS. 8 and 9.

The preferred exterior wiping seal 272 includes a lower seal wing 2721 and an upper seal wing 2722 both extending from an exterior wiping seal body 2723. The lower and upper seal wings 2721, 2722 extend at least partially towards the movable pane 243 of the window 24 and mate with the window 24 in an interference fit. The dual seal wings 2721, 2722 both wipe the surface of the movable pane 243 during raising and lowering of the movable pane 243. The double sealing provided by the dual seal wings 2721, 2722 improve the seal between the exterior wiping seal 272 and the window 24, thereby reducing the noise transmitted to the cabin 18 and helping to prevent external dust, dirt, mud, and other impurities from entering the cabin 18. The lower and upper seal wings 2722 both curve upwardly in their engagement with the movable pane 243, improving connection stability and wiping effect between the exterior wiping seal 272 and the window 24.

The exterior wiping seal body 2723 attaches to the door assembly 20 somewhat similarly to how the seal body 263 of the door frame seal 26 attaches to the door assembly 20. More particularly, the exterior wiping seal body 2723 includes an embedded reinforcement strip 2724 and defines a clamping slot 2725. Fins 2726 on the exterior wiping seal body 2723 extend inwardly and upwardly into the clamping slot 2725, and the exterior wiping seal body 2723 is attached with an exterior seal flange 221 of the exterior door panel 22 being received in the clamping slot 2725. The exterior seal flange 221 preferably extends substantially parallel to the surface of the window 24. The fins 2726 are barb-shaped to hold the exterior wiping seal 272 to the exterior seal flange 221 during raising and lowering of the movable pane 243. The fins 2726 help account for any imperfections or tolerances in the gap between the exterior door panel 22 and the window 24 seen during raising and lowering of the movable pane 243. It should be noted that some of the fins 2726 may be shorter than others, as long as connection between the exterior wiping seal body 2723 and the exterior door panel 22 is stable. In the preferred embodiment, the exterior seal flange 221 extends vertically upward where it is received in the clamping slot 2725 with the opening of the clamping slot 2725 oriented downwardly. The orientation of the fins 2726 prevent the exterior wiping seal 272 from easily detaching off of the exterior seal flange 221, thereby improving the stability of the connection between the exterior wiping seal 272 and the exterior door panel 22.

The exterior wiping seal body 2723 includes two curved entry edges 2727 which are unlike any structure on the seal body 263 of the door frame seal 26. The curved entry edges 2727 are positioned at the inner and outer sides of the mouth of the clamping slot 2725, and both curved entry edges 2727 extend in the same transverse direction relative to the vertically oriented clamping slot 2725, to the left as shown in FIGS. 8 and 9. With the curved entry edges 2727, installation of the exterior wiping seal body 2723 onto the exterior seal flange 221 involves a slight rotation of the exterior wiping seal 272 (clockwise as shown in FIGS. 8 and 9) rather than just pressing the exterior wiping seal 272 vertically downward onto the exterior seal flange 221.

As a preferred option, the preferred exterior wiping seal 272 also has a dust-resistive lip 2728 located on the upper side of the exterior wiping seal body 2723. The dust-resistive lip 2728 extends at least partially towards the window 24, so that the dust-resistive lip 2728 tends to prevent dust and other particulate impurities from gravitationally falling into and settling in the recess defined between the base of the upper seal wing 2721 and the exterior wiping seal body 2723.

With the exterior wiping seal 272 having two seal wings 2721, 2722, an exterior wiping seal drainage channel 2729 is cooperatively defined as the space below the upper seal wing 2722, above the lower seal wing 2721, outside of the window 24 and inside of the exterior wiping seal body 2723. The exterior wiping seal drainage channel 2729 is in fluid communication with the outside ambient conditions at one of its ends. Any precipitation or impurities that get pasted the upper seal wing 2722 can wash themselves out through the exterior wiping seal drainage channel 2729, thereby further improving the seal performance of the exterior wiping seal 272.

In the vertical cross-section shown in FIG. 9 and prior to installation in contact with the window 24, an extension length of each of the lower and upper seal wings 2721, 2722 along the width direction of the off-road vehicle 100 is defined as an undeflected exterior wiping wing distance D5. After installation and when pressing against the window 24, the horizontal distance between the exterior wiping seal body 2723 and the exterior surface of the window 24 is defined as an exterior wiping seal gap distance D6. The undeflected exterior wiping wing distance D5 is greater than the exterior wiping seal gap distance D6, causing the interference fit which improves the seal effect between the exterior door panel 22 and the window 24. After installation, the window 24 pushes the lower and upper seal wings 2721, 2722 laterally. An exterior wiping seal deflection ratio D6/D5 of the exterior wiping seal gap distance D6 to the undeflected exterior wiping wing distance D5 is preferably in the range from 50% to 76%, more preferably in the range from 56% to 69%, and most preferably about 63%. Designing the exterior wiping seal deflection ratio D6/D5 to be within these values allows for excellent sealing effect without overly increasing difficulty in raising and lowering the movable pane 243 due to friction between the lower and upper seal wings 2721, 2722 and the movable pane 243.

The interior wiping seal 273 is assembled onto the interior door panel 23 on the opposite side of the window 24 from the exterior wiping seal 272. Similar to the exterior wiping seal 272, the interior wiping seal 273 includes a lower seal wing 2731 and an upper seal wing 2732 both extending from an interior wiping seal body 2733. The seal wings 2731, 2732 of the interior wiping seal 273 are designed similar to the seal wings 2721, 2722 of the exterior wiping seal 272, mating with the window 24 in an interference fit and defining an interior wiping seal drainage channel 2734. However, because the interior wiping seal 273 is inside rather than outside the window 24, the interior wiping seal deflection ratio D8/D7 is different than the exterior wiping seal deflection ratio D6/D5.

Specifically, in the vertical cross-section shown in FIG. 9 and prior to installation in contact with the window 24, an extension length of each of the lower and upper seal wings 2731, 2732 along the width direction of the off-road vehicle 100 is defined as an undeflected interior wiping wing distance D7. After installation and when pressing against the window 24, the horizontal distance between the interior wiping seal body 2733 and the interior surface of the window 24 is defined as an interior wiping seal gap distance D8. The undeflected interior wiping wing distance D7 is greater than the interior wiping seal gap distance D8, causing the interference fit which improves the seal effect between the interior door panel 23 and the window 24. After installation, the window 24 pushes the lower and upper seal wings 2731, 2732 of the interior wiping seal 273 laterally, but not as much as it does for the exterior wiping seal 272. An interior wiping seal deflection ratio D8/D7 of the interior wiping seal gap distance D8 to the undeflected interior wiping wing distance D7 is preferably in the range from 63% to 95%, more preferably in the range from 71% to 87%, and most preferably about 79%. Designing the interior wiping seal deflection ratio D8/D7 to be within these values allows for excellent sealing effect without overly increasing difficulty in raising and lowering the movable pane 243 due to friction between the lower and upper seal wings 2731, 2732 and the movable pane 243. Moreover, the difference between exterior wiping seal deflection ratio D6/D5 and the interior wiping seal deflection ratio D8/D7 allows for proper adjustment to account for differing amounts of precipitation and impurities witnessed outside versus inside the window 24.

In the preferred embodiment, the interior door panel 23 is formed of a different material or different thickness than the exterior door panel 22. The exterior door panel 22 can be formed of sheet steel or sheet aluminum or a tough plastic such as polypropylene at sufficient thickness to be relatively rigid. The interior door panel 22 can be formed of a less rigid plastic, such as molded of a thinner sheet of polypropylene. Because of the difference in rigidity of the interior door panel 23 as compared to the exterior door panel 22, the seal body 2733 and its embedded reinforcement strip 2735 of the interior wiping seal 273 are shaped quite differently than the seal body 2723 and its reinforcement strip 2724 of the exterior wiping seal 272, and the interior wiping seal 273 attaches to the interior door panel 23 differently than the exterior wiping seal 272 attaches to the exterior door panel 22. Specifically, the interior door panel 23 is molded with one or more downwardly extending tabs 231 providing a plurality of plug-in through-holes 232. The seal body 2733 of the interior wiping seal 273 has a top attachment lip 2736 which runs over the interior door panel 23 throughout its length as well as a plurality of snap plugs 2737 each of which mate and snap into one of the plug-in through-holes 232. The interior wiping seal 273 is installed onto the interior door panel 23 by lining up the snap plugs 2737 with the plug-in through-holes 232 and pressing to snap the interior wiping seal 273 into place. The number and location of the snap plugs 2737 and corresponding plug-in through-holes 232 are designed based on the actual rigidity and strength needed.

If desired, the movement mechanism 25 for the movable pane 243 could be manual, such as including a hand crank (not shown). More preferably, the movement mechanism 25 includes a motor 251 as shown in FIGS. 2, 10 and 11 for driving the window 24 to move upwards or downwards. The hinges 28 and the motor 251 are both mounted on the door frame assembly 21.

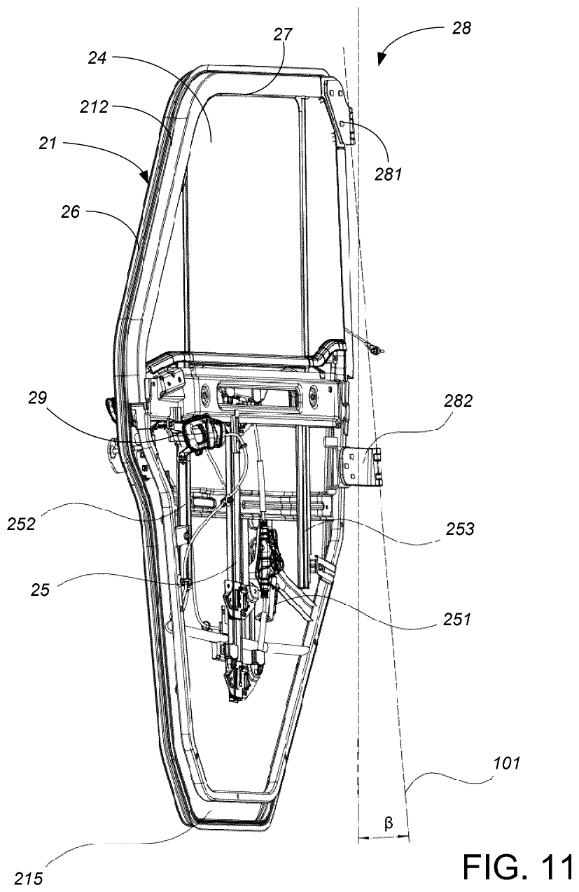

The hinges 28 define a door pivot axis 101 shown in FIG. 11. In the preferred embodiment, the door pivot axis is canted relative to vertical by a door cant angle β. The door cant angle β is preferably in the range from 1.5°-3° degrees, more preferably in the range from 2°-2.5°, and most preferably about 2.3°, oriented to gravitationally bias the door assembly 20 closed. Selection of a door cant angle β within these values allows for proper forces for opening and closing of the door assembly 20.

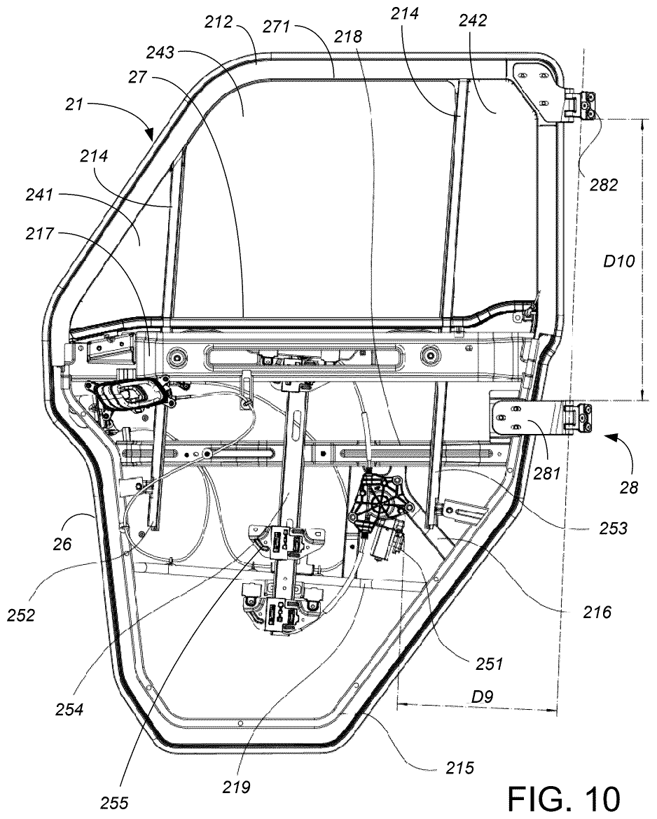

The minimum distance between the motor 251 and the door pivot axis 101 is defined as a motor offset distance D9 as called out in FIG. 10. The motor offset distance D9 is preferably in the range from 0 mm to 500 mm, more preferably in the range from 100 mm to 420 mm, and most preferably in the range from 150 mm to 300 mm. Having a small motor offset distance D9 avoids excessive shock and vibration of the motor 251 during closing of the door assembly 20, improving the service life of the lifting motor 251. At the same time, the motor 251 can be placed adjacent to the movable pane 243, making its wiring harness (not shown) shorter and easier to arrange.

A vertical distance between the two hinges 281, 282 is defined as a hinge span distance D10, called out in FIG. 10. A span-offset ratio D10/D9 of the hinge span distance D10 to the motor offset distance D9 is preferably in the range from 1.3 to 1.96, more preferably in the range from 1.46 to 1.8, and most preferably about 1.63. Having a span-offset ratio D10/D9 within these value ranges helps the weight of the motor 251 and its momentum during closing of the door assembly 20 from placing inordinate bending forces on the hinges 28, increasing service life of the hinges 28.

The door lock 29 is on the front side of the door frame assembly 21 opposite the hinges 28. The movement mechanism 25 for the movable pane 243 includes a front guide rail 252, a rear guide rail 253 and a center rail 254. The front guide rail 252 extends substantially vertically in line with a front edge of the movable pane 254 but behind the door lock 29, and the front guide rail 252 slidably supports the front edge of the movable pane 254. The rear guide rail 253 extends substantially vertically in line with a rear edge of the movable pane 254 and parallel to the front guide rail 252, and the rear guide rail 253 slidably supports the rear edge of the movable pane 254. The center rail 254 extends substantially vertically spaced between the front guide rail 252 and the rear guide rail 253. A window support base 255 slidably rides up or down on the center rail 254 as driven by the motor 251, and is connected to and supports a bottom edge of the movable pane 243. The motor 251 is preferably positioned rearward to the center rail 254 and forward of the rear guide rail 253, helping to allow appropriate values for the motor offset distance D9 and the span-offset ratio D10/D9.

The door frame assembly 21 further includes a lower door frame tube 215, a motor bracket 216, a upper crossbar 217, a middle crossbar 218 and a lower crossbar 219 as called out in FIG. 10. The lower door frame tube 215 preferably includes a seal clamping flange (not separately shown) having its structure and position consistent with the seal clamping flange 211 on the window frame 212 for securing the door frame seal 26. The motor bracket 216 is connected to the lower door frame tube 215 at an elevation between the middle crossbar 218 and the lower crossbar 219, and rigidly supports the motor 251. The lifting motor 251 may be bolted or otherwise connected to the motor bracket 216. The upper, middle and lower crossbars 217, 218, 209 run longitudinally, preferably substantially horizontally, connected to the lower door frame tube 215. In a preferred embodiment, the window frame 212, the lower door frame tube 215, the motor bracket 216, and the three crossbars 217, 218, 219 are all rigidly joined as a single weldment, with a leaf of the upper hinge 281 bolted to the window frame 212 and a leaf of the lower hinge 282 bolted to the lower door frame tube 215.

It should be understood that for those skilled in the art, improvements or transformations can be made based on the above description, and all such improvements and transformations should fall within the scope of protection of the claims attached to the present application.

1. An off-road vehicle comprising:
a frame;
a plurality of wheels supporting the frame;
a prime mover system supported by the frame for driving at least some of the plurality of wheels; and
a door assembly pivotally mounted on the frame, the door assembly comprising a door frame assembly, a door frame seal, and a window, the door frame seal being disposed around the door frame assembly to seal between the door assembly and the frame, the window being mounted on the door frame assembly and being transparent or translucent to allow viewing therethrough;
wherein the door frame seal comprises:
a seal body connected to the door frame assembly;
an exterior seal wing extending from the seal body; and
an interior seal wing extending from the seal body,
wherein the frame has an lateral contact surface and an side contact surface, the lateral contact surface being adjacent to the side contact surface and oriented differently from the side contact surface, and when the door assembly is in a closed state, the exterior seal wing abuts against the lateral contact surface in an interference fit without contacting the side contact surface, and the interior seal wing abuts against the side contact surface in an interference fit without contacting the lateral contact surface.

2. The off-road vehicle of claim 1, wherein the door frame assembly comprises a seal clamping flange, wherein the seal body of the door frame seal comprises a clamping slot, the seal body being mounted on the door frame assembly with the seal clamping flange received in the clamping slot, wherein the seal body of the door frame seal comprises at least one fin extending into the clamping slot at an acute angle relative to an insertion direction of the seal clamping flange into the clamping slot.

3. The off-road vehicle of claim 1, wherein an extension length of the exterior seal wing along a height direction of the off-road vehicle is defined as an undeformed exterior wing distance, wherein when the door assembly is closed, a vertical distance between the seal body and the lateral contact surface is defined as a peripheral door gap distance, wherein the undeformed exterior wing distance is greater than the peripheral door gap distance such that closing of the door causes the interference fit of the exterior seal wing, wherein an exterior seal deformation ratio of the peripheral door gap distance to the undeformed exterior wing distance is in the range from 58% to 88%.

4. The off-road vehicle of claim 1, wherein an extension length of the interior seal wing along a width direction of the off-road vehicle is defined as an uncompressed interior wing distance, wherein, when the door assembly is closed, a horizontal distance between the seal body and the side contact surface is defined as a door side gap distance, the door side gap distance being smaller than the uncompressed interior wind distance such that closing of the door causes the interference fit compressing the interior seal wing laterally, wherein an interior seal compression ratio of the door side gap distance to the uncompressed interior wing distance is in the range from 29% to 45%.

5. The off-road vehicle of claim 1, wherein the interior seal wing defines an internal cavity, the interior seal wing having a guide portion for controlling direction of deformation of the interior seal wing.

6. The off-road vehicle of claim 1, wherein when the door assembly is in a closed state, the frame, the exterior seal wing, and the interior seal wing cooperatively define a drainage channel in fluid communication for drainage outside the vehicle.

7. The off-road vehicle of claim 1, wherein the seal body comprises an embedded reinforcement strip formed of metal.

8. The off-road vehicle of claim 1, wherein the window has at least one movable pane, wherein the door frame assembly comprises a window frame around the window, the window frame defining a seal clamping slot, wherein a window seal is mounted at least partially within the seal clamping slot to seal between the movable pane and the window frame, the window seal having an exterior pane receiving wing abutting in an interference fit against an outer surface of the movable pane when the movable pane is closed, the window seal having an interior pane receiving wing abutting in an interference fit against an inner surface of the movable pane when the movable pane is closed.

9. The off-road vehicle of claim 1, wherein the window has at least one movable pane, wherein the door frame assembly comprises a window frame around the window, the window frame defining a seal clamping slot, wherein a window seal is mounted at least partially within the seal clamping slot to seal between the movable pane and the window frame, the window seal having a top edge wing which, when the movable pane is closed, abuts in an interference fit against a top edge of the movable pane.

10. The off-road vehicle of claim 1, wherein the window has at least one fixed pane and at least one movable pane, wherein the door frame assembly comprises a window frame around the window and a side window frame between the fixed pane and the movable pane, the side window frame being bolted to the window frame, and further comprising a wrapping corner have a bolt receiving recess covering at least one bolt fixing the side window frame to the window frame.

11. The off-road vehicle of claim 1, wherein the door assembly comprises an exterior door panel and an interior door panel both secured to the door frame assembly, wherein the window has at least one movable pane, wherein an exterior wiping seal is secured to the exterior door panel in an interference fit with an exterior surface of the movable pane, and wherein an interior wiping seal is secured to the interior door panel in an interference fit with an interior surface of the movable pane.

12. The off-road vehicle of claim 11, wherein the exterior wiping seal has lower and upper seal wings extending from an exterior wiping seal body, and wherein the interior wiping seal has lower and upper seal wings extending from an interior wiping seal body.

13. The off-road vehicle of claim 11, wherein the exterior wiping seal has an exterior wiping seal body defining a clamping slot, with the exterior door panel having an exterior seal flange that is received in the clamping slot of the exterior wiping seal body to secure the exterior wiping seal to the exterior door panel, wherein the interior wiping seal has an interior wiping seal body with a snap plug snapped into a plug-in through-hole in the interior door panel to secure the interior wiping seal to the interior door panel.

14. The off-road vehicle of claim 11,
wherein the exterior wiping seal has at least one exterior seal wing extending from an exterior wiping seal body,
wherein, prior to installation in contact with the window, an extension length of the exterior seal wing along the width direction of the off-road vehicle is defined as an undeflected exterior wiping wing distance, and after installation and when pressing against the window, a horizontal distance between the exterior wiping seal body and an exterior surface of the movable pane is defined as an exterior wiping seal gap distance, with an exterior wiping seal deflection ratio of the exterior wiping seal gap distance to the undeflected exterior wiping wing distance in the range from 50% to 76%;
wherein the interior wiping seal has at least one interior seal wing extending from an interior wiping seal body; and
wherein, prior to installation in contact with the window, an extension length of the interior seal wing along the width direction of the off-road vehicle is defined as an undeflected interior wiping wing distance, and after installation and when pressing against the window, a horizontal distance between the interior wiping seal body and the interior surface of the movable pane is defined as an interior wiping seal gap distance, with an interior wiping seal deflection ratio of the interior wiping seal gap distance to the undeflected interior wiping wing distance in the range from 63% to 95%, the interior wiping seal deflection ratio being greater than the exterior wiping seal deflection ratio.

15. An off-road vehicle comprising:
a frame;
a plurality of wheels supporting the frame;
a prime mover system supported by the frame for driving at least some of the plurality of wheels; and
a door assembly pivotally mounted on the frame, the door assembly comprising a door frame assembly, a door frame seal, a window, an exterior door panel and an interior door panel, the door frame seal being disposed around the door frame assembly to seal between the door assembly and the frame, the window being mounted on the door frame assembly and being transparent or translucent to allow viewing therethrough, the exterior door panel and the interior door panel both secured to the door frame assembly;
wherein the window has at least one movable pane;
wherein an exterior wiping seal is secured to the exterior door panel, the exterior wiping seal having lower and upper seal wings extending from an exterior wiping seal body, the exterior wiping seal body being secured to the exterior door panel such that the lower and upper seal wings of the exterior wiping seal are in an interference fit with an exterior surface of the movable pane; and
wherein an interior wiping seal is secured to the interior door panel, the interior wiping seal having lower and upper seal wings extending from an interior wiping seal body, the interior wiping seal body being secured to the interior door panel such that the lower and upper seal wings of the interior wiping seal are in an interference fit with an interior surface of the movable pane.

16. The off-road vehicle of claim 15, wherein the exterior wiping seal body defines a clamping slot, with the exterior door panel having an exterior seal flange that is received in the clamping slot of the exterior wiping seal body to secure the exterior wiping seal to the exterior door panel, wherein the interior wiping seal body has a snap plug extending therefrom, the snap plug being snapped into a plug-in through-hole in the interior door panel to secure the interior wiping seal to the interior door panel.

17. The off-road vehicle of claim 15,
wherein, prior to installation in contact with the window, an extension length of the seal wings of the exterior wiping seal along the width direction of the off-road vehicle is defined as an undeflected exterior wiping wing distance, and after installation and when pressing against the window, a horizontal distance between the exterior wiping seal body and an exterior surface of the movable pane is defined as an exterior wiping seal gap distance, with an exterior wiping seal deflection ratio of the exterior wiping seal gap distance to the undeflected exterior wiping wing distance in the range from 50% to 76%;
wherein, prior to installation in contact with the window, an extension length of the seal wings of the interior wiping seal along the width direction of the off-road vehicle is defined as an undeflected interior wiping wing distance, and after installation and when pressing against the window, a horizontal distance between the interior wiping seal body and the interior surface of the movable pane is defined as an interior wiping seal gap distance, with an interior wiping seal deflection ratio of the interior wiping seal gap distance to the undeflected interior wiping wing distance in the range from 63% to 95%, the interior wiping seal deflection ratio being greater than the exterior wiping seal deflection ratio.

18. The off-road vehicle of claim 15, wherein the door frame assembly comprises a window frame around the window, the window frame defining a seal clamping slot, wherein a window seal is mounted at least partially within the seal clamping slot to seal between the movable pane and the window frame, the window seal having a top edge wing which, when the movable pane is closed, abuts in an interference fit against a top edge of the movable pane.

19. The off-road vehicle of claim 18, wherein the window seal further has an exterior pane receiving wing abutting in an interference fit against an outer surface of the movable pane when the movable pane is closed, and an interior pane receiving wing abutting in an interference fit against an inner surface of the movable pane when the movable pane is closed.

20. An off-road vehicle comprising:
a frame;
a plurality of wheels supporting the frame;
a prime mover system supported by the frame for driving at least some of the plurality of wheels; and
a door assembly pivotally mounted on the frame, the door assembly comprising a door frame assembly, a door frame seal, and a window, the door frame seal being disposed around the door frame assembly to seal between the door assembly and the frame, the window being mounted on the door frame assembly and being transparent or translucent to allow viewing therethrough;
wherein the window has at least one movable pane;
wherein the door frame assembly comprises a window frame around the window, the window frame defining a seal clamping slot;
wherein a window seal is mounted at least partially within the seal clamping slot to seal between the movable pane and the window frame, the window seal comprising:
a top edge wing which, when the movable pane is closed, abuts in an interference fit against a top edge of the movable pane;
an exterior pane receiving wing abutting in an interference fit against an outer surface of the movable pane when the movable pane is closed; and
an interior pane receiving wing abutting in an interference fit against an inner surface of the movable pane when the movable pane is closed.
